(19) United States
(12) Patent Application Publication
(10) Pub. No.: US 2013/0047095 A1
(43) Pub. Date: Feb. 21, 2013

(54) CLOUD DESKTOP SYSTEM WITH MULTI-TOUCH CAPABILITIES

(71) Applicants: Oscar Divorra Escoda, Barcelona (ES); David Espinola Torrent, Barcelona (ES)

(72) Inventors: Oscar Divorra Escoda, Barcelona (ES); David Espinola Torrent, Barcelona (ES)

(21) Appl. No.: 13/577,315

(22) PCT Filed: Feb. 3, 2011
(86) PCT No.: PCT/EP2011/051547

§ 371 Date: Nov. 6, 2012

Related U.S. Application Data
(60) Provisional application No. 61/302,291, filed on Feb. 8, 2010.

(51) Int. Cl. G06F 3/01

(52) U.S. Cl. 715/753

(57) ABSTRACT

The present invention provides a collaborative tool which is a distributed multi-touch cloud-connected desktop tool comprising a client application and/or webtop with an integrated immersive Natural User Interface adapted for any input device having a touch screen. Thanks to the invention users can access their desktops from everywhere, at anytime and from any capable device, as the desktop is multiplatform and can be accessed from mobile devices, web browsers or from desktops as standalone application without the necessity of a desktop computer. Thanks to the invention, users can share digital content, edit it and interact with it in a cooperative and collaborative manner while still able to individually and independently arrange objects and/or applications in each of the clients for the best convenience of each user.

### FIELD OF THE INVENTION

The present invention refers to a collaboration tool that is accessible by multiple users simultaneously through different sources. In particular, the invention refers a system and method for sharing a collaboration environment based on a set of connected user interface surface end-points with multi-touch capabilities, where applications and objects share their digital contents and the interaction with these among end-points. This allows each end-point to independently place and configure each application and object within its user interface, while digital contents of each application and the user interaction with them are shared (thanks to the connected properties of the user interface).

### BACKGROUND OF INVENTION

Real-time collaboration including audio, video and web conferencing products and services is becoming more and more relevant in recent years.

Multi-touch surfaces offer a more intuitive and natural interaction with PCs, transforming the way we use computers, much the way GUI systems did when they were introduced 25 years ago. While some tasks may still be easier to perform using traditional input devices like the keyboard and mouse, multi-touch is ideal for manipulating objects; creating, editing, and browsing pictures; navigating maps; and even surfing the Web. Gesture-based human/computer interaction represents an evolutionary step, not just in the design of hand-held devices and PCs but also in the look, feel, and functionality of websites.

There are a lot of (multi)touch solutions available on the market. Starting from (multi)touch overlays, there are two interesting solutions: the first one provided by PQLab, which offers overlays of sizes until 52 inches; and the second one provided by Next Window. Moreover, NuiGroup, Startum, Perspective Pixel, (multi)touchOy and Tyco electronics offer their (multi)touch LCD solutions, and as for (multi)touch tables, we can find Ideum MT2, Smart Table, IntuiFace, GestureTek and Microsoft. Finally, some commercial (multi)touch tablets of HP and Dell are also available (multi)touch options.

As for operating systems for the mentioned applications, there are web operating systems commonly referred to as Web desktops. A web desktop or webtop is a network application system for integrating web applications into a web based work space. It is a virtual desktop on the web, running in a web browser as software. Web desktops often are characterized by an environment similar to that of Windows, Mac, or Linux, but are now considered to have much more functionality being dependent on the internet. Typical benefits include the ability to save work and settings over the internet rather than to the local desktop. There are a lot of useful Web desktops on the market as EyeOS, AmoebaOS, G.ho.st and Glide.

However, none of these tools has a really Natural User Interface (NUI) integrated on it. This is because they have been designed as normal webs and they give more priority to functionality than usability. It is important to say that Natural User Interface is a way of defining a user interface that is effectively invisible, or becomes invisible to its users with successive learned interactions. The word “natural” is used because most computer interfaces use artificial control devices whose operation has to be learned. A NUI relies on a user being able to carry out relatively natural movements or gestures with which they quickly discover they can control the computer application or manipulate the on-screen content. The most descriptive identifier of a NUI is the lack of a physical keyboard and/or mouse.

None of the above commented tools supports (multi)touch capabilities. Consequently, they cannot be used without mouse and keyboard devices. Moreover, most of them are not multiplatform and they are only supported by the Windows Operating System. Also, non of the tools support multi-point distributed collaboration, they do not share application contents and they do not share collaborative interaction with these contents while keeping desktops independent.

Another disadvantage of the previously commented applications is that they are, in the best of cases a single desktop that is fully shared and viewed by the different users in the collaboration. This impairs the possibility to independently distribute and configure applications and objects in each desktop while sharing digital contents and user's interactions with these.

### SUMMARY OF THE INVENTION

The present invention aims to solve the problems discussed above by providing a collaborative tool which is a (multi)touch cloud-connected distributed desktop tool for the purpose of collaboration comprising a set of web desktops and/or webtops with an integrated immersive Natural User Interface adapted for any input device having a touch screen. These desktops and webtops are connected through at least one server in the “cloud” which allows different applications within the distributed sets of desktops and/or webtops to share digital content and users interaction from each desktop and/or webtop. Eventually, the tool comprises one or more of the following applications: Shared Whiteboard for co-drawing, shared WebBrowser for co-browsing, shared Text Editor for co-edition, Shared Media Player for co-visualization of content in a distributed and simultaneous manner, Shared Slide/Document Viewer for co-presentation and/or co-viewing of shared documents, Video/Audio Conference, Instant Messaging, connected Online games for co-playing, Shared Image viewer for co-visualization of pictures, Shared Virtual Desktop such as a shared VNC client for co-use of applications in a remote virtualized session and File Sharing. The tool is also adapted to receive user input also from external keyboards, mice and dc/dvd devices besides the (multi)touch interface.

The system of the invention is a system for tellecolaboration and sharing digital content and the interaction with this among clients. In an embodiment of this invention, the system comprises at least one server for storing the information to be shared in the cloud and managing the user connection and collaboration sessions and a multi-touch tool with an immersive NUI and wherein each client is provided with an Adobe AIR application or a Flex application run from a web browser. In an embodiment of this invention, the server is composed of both a Red5 and an XAMPP system.

### BRIEF DESCRIPTION OF THE DRAWINGS

To complete the description and in order to provide for a better understanding of the invention, a set of drawings is provided. Said drawings illustrate a preferred embodiment of the invention, which should not be interpreted as restricting the scope of the invention, but just as an example of how the invention can be embodied. The drawings comprise the following figures:

FIG. 1.—shows an exemplary system diagram.

FIG. 2.—is a block diagram of the system's architecture.

FIG. 3.—is a flow diagram of how Red 5 propagates shared actions.

FIG. 4.—is a flow diagram of video/audio streaming between two clients.

FIG. 5.—shows a simplified diagram of a room's architecture.

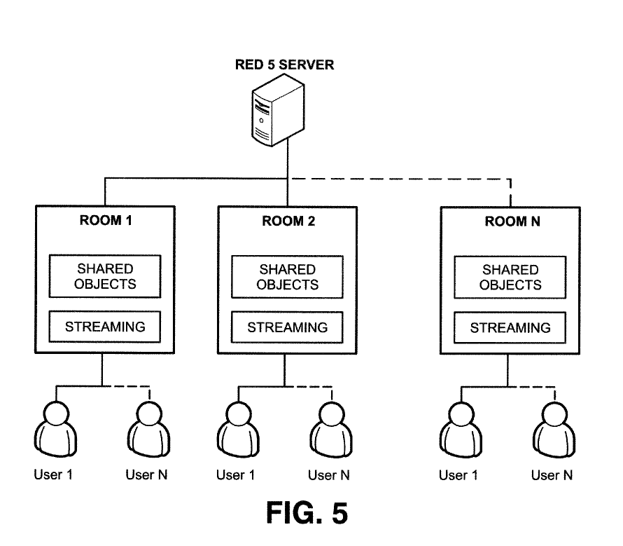

### DESCRIPTION OF THE INVENTION

In this invention, we propose a real time tele-collaboration environment, based on a cloud architecture, that use a Natural User Interface, supports (multi)touch gestures, allows simultaneous interaction between multiple participants over a set of shared contents and allows for cheaper implementations than existing solutions.

Firstly, a collaborative desktop application and webtop is built as a cloud service, where everyone can access his/her desktop and contents from everywhere and at anytime, from any capable device through the Internet. Moreover, this environment is multiplatform and it can be run as a web page from a normal web browser. Furthermore, it is also accessible as standalone application (e.g., through Adobe AIR) or from a mobile device.

Secondly, real time collaboration tools will be provided to the desktop so users can share with other participants who are logged on the same space while allowing each user to arrange his/her desktop in an independent way. The list of collaboration tools that can be added is very big, and comprise amongst other: Shared Whiteboard for co-drawing, shared WebBrowser for co-browsing, shared Text Editor for co-edition, Shared Media Player for co-visualization of content in a distributed and simultaneous manner, Shared Slide/Document Viewer for co-presentation and/or co-viewing of shared documents, Video/Audio Conference, Instant Messaging, connected Online games for co-playing, Shared Image viewer for co-visualization of pictures, Shared Virtual Desktop such as a shared VNC client for co-use of applications in a remote virtualized session and File Sharing.

The first essential characteristic of the invention is an immersive NUI that supports (multi)touch gestures (at least one of a rotate, scale and drag the elements of the application) and makes the interaction between the user and the system more natural and intuitive than existing applications.

Also, each connected end-point has the capability to independently arrange each object and/or application in an independently manner with respect to the rest of end-points. This is performed with at least one of a (multi)touch input through the NUI, pointer input from a pointing device such a mouse and an external keyboard.

Digital content from objects and/or applications is shared among different end-points (or clients) and users by means of connected capabilities through at least one server in the “cloud”.

Interaction with digital content is also shared among the different end-points by reflecting the actions performed in an end-point to the rest of end-points by means of connected capabilities through at least one server in the “cloud”.

In the first embodiment two versions of the same client with Adobe technology are provided; the first one is an Adobe AIR application that can be run as standalone application, the second one is a Flex application that is run from a web browser. Both clients have the same aspect and features. Moreover, both are able to receive user input from keyboards, mice, cd/dvd and (multi)touch devices.

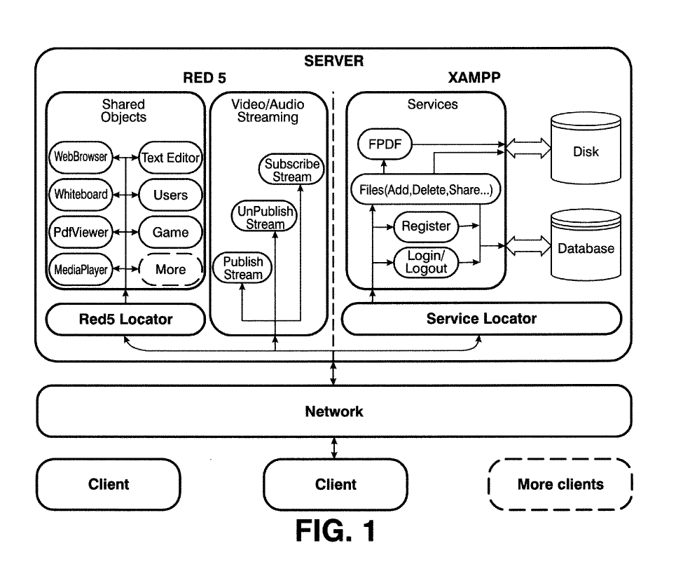

FIG. 1 is an exemplary system for implementing this invention. The client uses the network interface of the system to interact with the server which is integrated on Red5, an open-source flash server, and XAMPP.

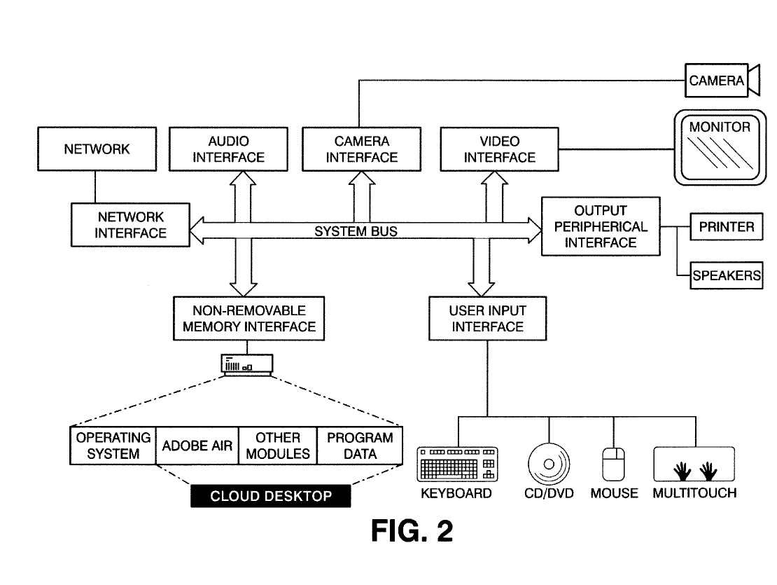

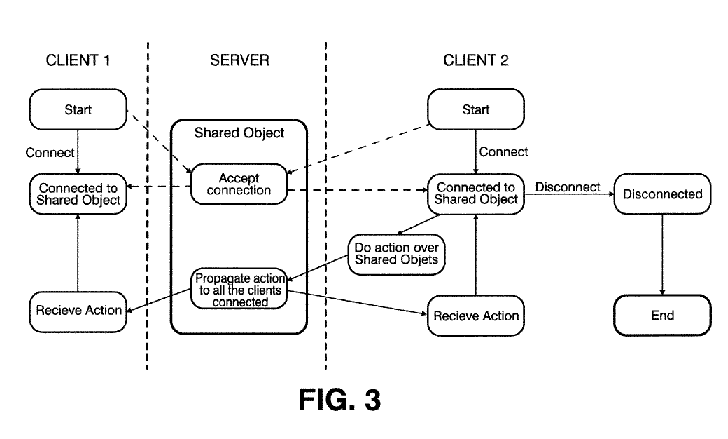

The block diagram of FIG. 2 shows a possible architecture according to the invention. With reference to this figure we can see that the block of the server is composed by a Red5 system and a XAMPP system. The first one, Red5, is used to stream video and audio between the clients that publish and subscribe their streams. Red 5 services have been implemented using Eclipse and Java. Furthermore, Red 5 is also used to replicate actions over some shared objects. FIG. 3 shows how Red5 propagates shared actions. Here there is defined one shared object for each collaboration component that we have on the application (e.g., web browser, whiteboard, text editor, pdf viewer, media player . . . ). In this flow diagram, client 1 and client 2 connect over the same shared object. After that, if client 2 does an action (e.g., draw something on the whiteboard, click next page of presentation . . . ) this action will be propagated over Red5 to client 1 and client 2. Red5 can support over 200 clients connected on the same shared object or stream. Of course, this number will oscillate depending on the application and the hardware used on the server.

Note that all Shared Objects are ‘Remote Shared Objects’ and they are stored on the Server and not on the AIR/Flex client.

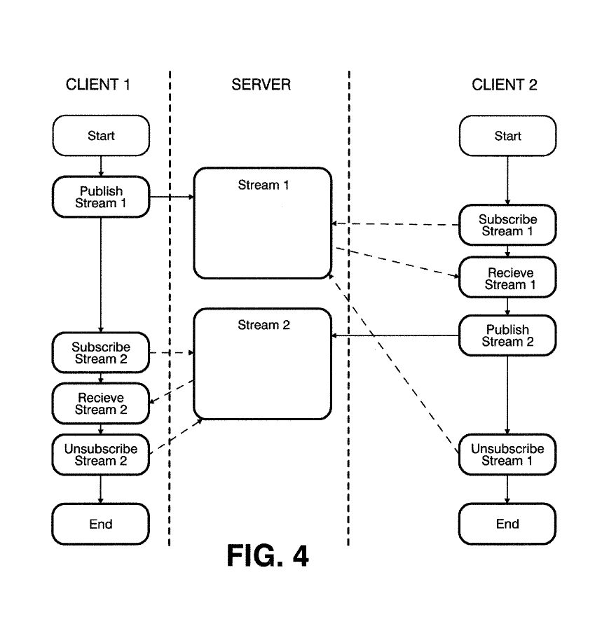

On the other hand, Red 5 is also used to stream video and audio. FIG. 4 shows the flow diagram between two clients that want to share their streamings.

The second part of the server is XAMPP that is a free and open source cross-platform web server package that includes Apache HTTP Server, MySql database, and interpreters for scripts written in the PHP and Peri programming languages.

XAMPP is used to access the database that contains all the information of the application, to upload files from the client to the server and finally to add a javascript layer to each pdf file.

This javascript layer is necessary to control when the user changes the page or makes zoom over the document. Moreover, this layer forces the file to be opened without the typical menus of the Acrobat Reader and using full screen.

The addition of the javascript layout to the pdf file is done through Fpdf and Fpdi opensource libraries.

With reference to the hardware part, one embodiment of the invention incorporates a (multi)touch overlay of 32″ from PQLABS. Its SDK supports FLEX and AIR and is therefore preferred. Moreover, PQLABS have already implemented some of the typical (multi)touch gestures as resize, rotate, etc. in their SDK. In each tabletop an independent management of the position and organization of applications and objects is made possible, while their content can be shared.

In another embodiment of this invention, it is also possible to define telecollaboration independent room environments in the application. This feature makes this invention more consistent and scalable because it adds the ability to accept increased volume of users and handle growing amounts of work in a graceful manner. All the users connected to the same room are able to interact over the shared components of that room. Furthermore, this invention can handle multiple rooms with multiple users connected simultaneously. In order to add persistence to this aspect, load balancing techniques would be a good solution to distribute the work between the servers where a big number of users are connected at the same time.

The invention is particularly useful when applied to a multi-screen telepresence system implementing a shared persons space around a table. In an embodiment of this invention, each full table of an “around-the-table” telepresence system can be one of the connected client desktops described in this invention.

The system of the invention implements and has the functions of a graphical, touch-immersive/gestural, collaborative and multiuser (with simultaneous collaboration among users) cloud-based operating system. Thanks to the invention users can access their desktops from everywhere, at anytime and from any capable device, as the desktop is multiplatform and can be accessed from mobile devices, web browsers or from desktops as standalone application without the necessity of a computer. The invention is furthermore a good framework to integrate in the future other Cloud APIs and applications, such as connected online games.

In this text, the term “comprises” and its derivations (such as “comprising”, etc.) should not be understood in an excluding sense, that is, these terms should not be interpreted as excluding the possibility that what is described and defined may include further elements, steps, etc.

On the other hand, the invention is obviously not limited to the specific embodiment(s) described herein, but also encompasses any variations that may be considered by any person skilled in the art (for example, as regards the choice of components, configuration, etc.), within the general scope of the invention as defined in the claims.

1. A multi-touch, cloud-site distributed desktop allowing distributed collaboration in a diversity of applications where application contents and the interaction with them are shared among a plurality of end-point clients, and where each end-point client allows for an independent arrangement and manipulation of each site instance of the shared applications, the distributed desktop being characterized in that it comprises a plurality of webtops, each with an integrated immersive Natural User Interface adapted for any input device having a touch screen.

2. A The multi-touch tool according to claim 1 further comprising one or more of the following applications: Shared Whiteboard, shared WebBrowser, Co-Text Editor, Shared Desktop, Shared Media Player, Co-Slide Show, Video/Audio Conference, Instant Messaging, Online games or Share files.

3. A multi-touch tool according to claim 1 adapted to receive user input also from keyboards, mice and dc/dvd devices.

4. A system for telecolaboration, sharing digital content and sharing the interaction with that content among clients comprising a server for storing the information to be shared, a multi-touch tool according to claim 1 and a plurality of touch-overlays.

5. The system according to claim 4 wherein each client is provided with an Adobe AIR application or a Flex application that is run from a web browser.

6. The system according to claim 4 wherein the server is composed of both a Red5 and an XAMPP system.

7. The system according to claim 4 adapted so objects and/or applications can be arranged individually and independently in each of the overlays while their content is shared between users.

8. The multi-touch tool according to claim 2 adapted to receive user input also from keyboards, mice and dc/dvd devices.

9. The system according to claim 5 wherein the server is composed of both a Red5 and an XAMPP system.

10. The system according to claim 9 adapted so objects and/or applications can be arranged individually and independently in each of the overlays while their content is shared between users.
